(19) United States
(12) Patent Application Publication
(10) Pub. No.: US 2006/0154654 A1
(43) Pub. Date: Jul. 13, 2006

(54) Method and system for the automated answering and holding of a call

(75) Inventors: Fadi R. Jabbour, Sunnyvale, CA (US); David C. Lee, Sunnyvale, CA (US); Johnny H. Lee, Mountain View, CA (US); Craig A. Cotton, Gurnee, IL (US)

Correspondence Address: BAKER BOTTS L.L.P., 2001 ROSS AVENUE, SUITE 600, DALLAS, TX, 75201-2980, US

(73) Assignee: Cisco Technology, Inc.

(21) Appl. No.: 11/031,179

(22) Filed: Jan. 7, 2005

(51) Int. Cl. H04M 3/42

(52) U.S. Cl. 455/417

(57) ABSTRACT

In accordance with a particular embodiment of the present invention, a method for the automated answering and holding of a call includes receiving an incoming call directed to a first endpoint from a second endpoint. A detection is made that the first endpoint is communicating with a third endpoint on a previous call. An indication is received from a recipient of the incoming call that the recipient desires the incoming call to be automatically answered and held. The incoming call from the second endpoint is automatically answered without interrupting the previous call, and the incoming call from the second endpoint is placed in a queue.

### TECHNICAL FIELD OF THE INVENTION

This invention relates in general to communication systems and, more particularly, to a method and system for the automated answering and holding of a call.

### BACKGROUND OF THE INVENTION

The field of communications has become increasingly important in today's society. In particular, the ability to quickly and effectively interact with an individual (through any suitable communications media) presents a significant obstacle for component manufacturers, system designers, and network operators. This obstacle is made even more difficult due to the plethora of diverse communication technologies (e.g. Instant Messaging, cellular communications, simple voice sessions, etc.) that exist in the current marketplace.

As new communication platforms (such as session initiation protocol (SIP), for example) become available to the consumer, new protocols need to be developed in order to optimize this emerging technology. For example, problems are often encountered by a recipient of overlapping calls. Where the recipient of an incoming call is participating in a previous call when the incoming call is received, the recipient typically must put the first call on hold before the recipient is able to answer the second call. Thus, communication with a first caller must be interrupted for the recipient to initiate a communication session with a second caller. Alternatively, the recipient may allow the second call to go unanswered or to be directed to a messaging system. Accordingly, the recipient may be prevented from timely and adequately communicating with the calling party or from properly covering incoming calls. This deficiency presents an obstacle for any employee, employer, individual, or endpoint that seeks to execute successful and productive communication sessions.

### SUMMARY OF THE INVENTION

The present invention provides a method and system for the automated answering and holding of a call that substantially eliminates or reduces some of the disadvantages and problems associated with previous methods and systems.

In accordance with a particular embodiment of the present invention, a method for the automated answering and holding of a call includes receiving an incoming call directed to a first endpoint from a second endpoint. A detection is made that the first endpoint is communicating with a third endpoint on a previous call. An indication is received from a recipient of the incoming call that the recipient desires the incoming call to be automatically answered and held. The incoming call from the second endpoint is automatically answered without interrupting the previous call, and the incoming call from the second endpoint is placed in a queue.

Certain embodiments of the present invention may provide a number of technical advantages. For example, according to one embodiment of the present invention, an architecture and a process are provided that allow for the automated answering and holding of an incoming call. As a result, the recipient of an incoming call may finish a previous call without interruption. A further technical advantage may be that the participant(s) in the previous call need not know that the end user has received an incoming call and need not know that the end user is finishing the call with them to take the incoming call. As a further advantage, the end user receiving an incoming call may avoid time-consuming endeavors, such as call-backs, that inhibit productivity. For example, an incoming and missed call may initiate a cycle of unproductive call backs if the recipient of the incoming call later returns the call only to find the other party unavailable. The answer and hold feature helps to prevent such cases.

Additionally, in particular embodiments, the invocation of the answer-and-hold feature may be on a real-time basis as the incoming call is received. In other embodiments, a registration system may be used to automatically invoke the answer-and-hold feature. For example, where presence is detected and managed, an end user may pre-register to place himself in a pending-ready state before an incoming call is received. A decision to invoke the answer-and-hold feature on this basis may involve decisions based on the status of a call currently underway. For example, if the call is close to terminating, the end user may press a soft-key on the user's telephone to register the user as willing to receive incoming calls on an automatic answer-and-hold basis. By registering to have incoming calls automatically answered, a user may proactively decide what the best action is to cover incoming calls.

Moreover, the proffered architecture can provide a simple interface to initiate the automatic answer-and-hold feature. The architecture can interpret a person's intention based on the depressed button selection. For example, in the case of a ringing phone icon being depicted on a display, if the end user presses the answer-and-hold button, then the communications system understands that the end user would like the call to be automatically answered. In another instance, where the same phone is not ringing, pressing the button would indicate that the end user would like any calls received in the future to be automatically answered and held. The system may rely on the end user button selection to execute a subsequent function or operation.

Additionally, in more simplistic scenarios, the answer-and-hold feature may allow a receiving party to have all incoming calls covered. As a result, a higher number of successful calls may be completed using the answer-and-hold feature, which vastly improves efficiency parameters (particularly in the workplace). Furthermore, such a protocol may be performed with minimal individual effort from the receiving party, as some or all of the answer-and-hold operations may be performed autonomously.

Other technical advantages will be readily apparent to one skilled in the art from the following figures, descriptions and claims. Moreover, while specific advantages have been enumerated above, various embodiments may include all, some or none of the enumerated advantages.

### BRIEF DESCRIPTION OF THE DRAWINGS

For a more complete understanding of the present invention and its advantages, reference is now made to the following description, taken in conjunction with the accompanying drawings, in which:

FIG. 1 illustrates a communication system that may implement an answer-and-hold feature in accordance with a particular embodiment of the present invention;

FIG. 2 illustrates a call manager of FIG. 1 in more detail, illustrating aspects of the present invention; and

FIGS. 3A and 3B illustrate an example method for implementing an answer-and-hold feature, in accordance with an embodiment of the present invention.

### DETAILED DESCRIPTION OF THE INVENTION

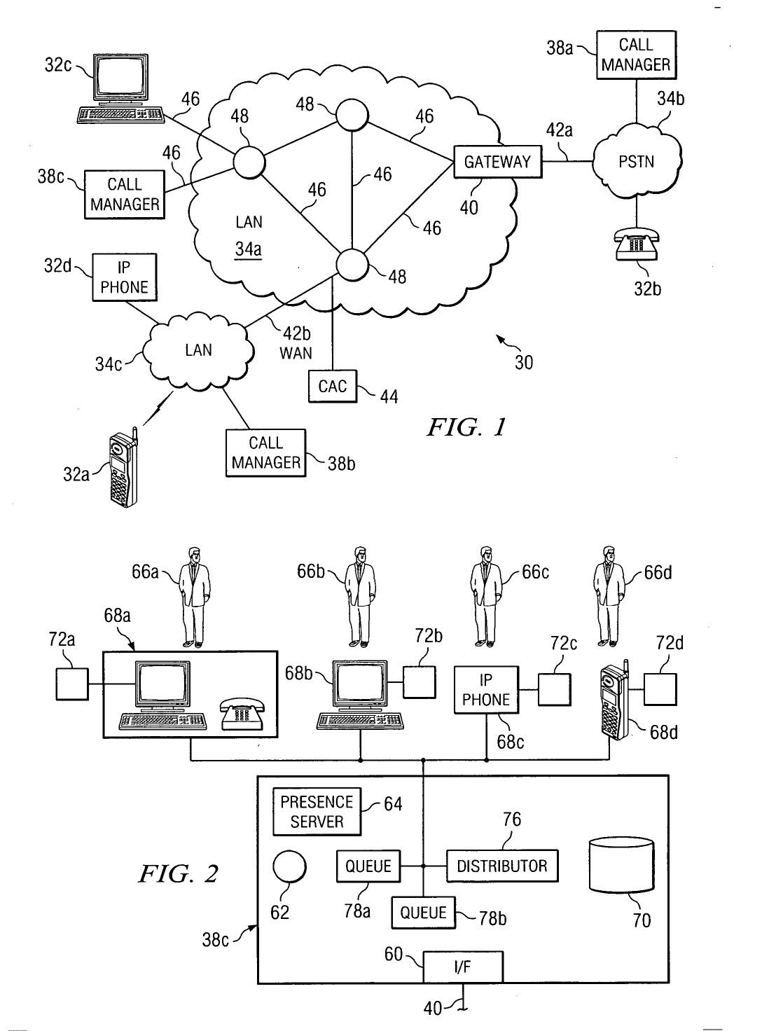

FIG. 1 illustrates a communication system 30 that may implement an answer-and-hold feature in accordance with a particular embodiment of the present invention. System 30 includes a plurality of endpoints 32a-32d having the ability to establish communication sessions between each other, using one or more of communication networks 34a-34c. In particular embodiments, system 30 also includes one or more call managers 38 which operate in cooperation with gateway 40 and endpoints 32a-d to answer incoming calls and implement the answer-and-hold feature. For example, when an incoming call is received a user of an endpoint 32a-32d may be able to invoke the answer-and-call feature to result in the automatic answering and holding of the incoming call. In other embodiments, the answer-and-hold feature may be automatically invoked by a call manager 38.

It will be recognized by those of ordinary skill in the art that endpoints 32a-32d, call manager 38a-c, and/or gateway 40 may be any combination of hardware, software, and/or encoded logic that provides communication services to a user. For example, each endpoint 32a-32d may include a telephone, a computer running telephony software, a video monitor, a camera, an IP phone, a cell phone or any other communication hardware, software, and/or encoded logic that supports the communication of packets of media (or frames) using communication networks 34a-34c. Endpoints 32a-32d may also include unattended or automated systems, gateways, other intermediate components, or other devices that can establish media sessions. Although FIG. 1 illustrates a particular number and configuration of endpoints, call managers, segments, nodes, and gateways, communication system 30 contemplates any number or arrangement of such components for communicating media.

In the illustrated embodiment, communication network 34a is a local area network (LAN) that enables communication between a plurality of endpoints 32a-32d distributed across multiple cities and geographic regions. Communication network 34b is a public switched telephone network (PSTN) and couples endpoint 32a with communication network 34a through gateway 40. Communication network 34c is another LAN, which couples endpoints 32a and 32d with communication network 34a. Accordingly, users of endpoints 32a-32d can establish communication sessions between and among each network component coupled for communication with one or more of networks 34a-34c. Communication links 42a and 42b couple communication networks 34a and 34b, and communication networks 34a and 34c, respectively. In the illustrated embodiment, communication link 42b is a wide area network (WAN), which couples LANs 34a and 34c. A call admission control (CAC) system 44 may be used to monitor the amount of bandwidth available over WAN 42b.

Communication network 34a includes a plurality of segments 46 and nodes 48 that couple endpoint 32a with call managers 38a and 38c, gateway 40, and communication networks 34b-34c. Therefore, a user of endpoint 32a is provided with access to endpoints 32b-32d. Nodes 48 may include any combination of network components, gatekeepers, call managers, routers, hubs, switches, gateways, endpoints, or other hardware, software, or embedded logic implementing any number of communication protocols that allow for the exchange of packets in communication system 30.

Although the illustrated embodiment includes three communication networks 34a-34c, the term “communication network” should be interpreted as generally defining any network capable of transmitting audio and/or video telecommunication signals, data, and/or messages, including signals, data or messages transmitted through text chat, instant messaging and e-mail. Any one of networks 34a-34c may be implemented as a local area network (LAN), wide area network (WAN), global distributed network such as the Internet, Intranet, Extranet, or any other form of wireless or wireline communication network. Generally, network 34a provides for the communication of packets, cells, frames, or other portions of information (generally referred to as packets herein) between endpoints 32a-32d. Communication network 34a may include any number and combination of segments 40, nodes 41, endpoints 32a-32d, and/or call managers 38a-34c.

In a particular embodiment, communication network 34a employs voice communication protocols that allow for the addressing or identification of endpoints, nodes, and/or call managers coupled to communication network 34a. For example, using Internet protocol (IP), each of the components coupled together by communication network 34a in communication system 30 may be identified in information directed using IP addresses. In this manner, network 34a may support any form and/or combination of point-to-point, multicast, unicast, or other techniques for exchanging media packets among components in communication system 30. Any network components capable of exchanging audio, video, or other data using frames or packets, are included within the scope of the present invention.

Network 34a may be directly coupled to other IP networks including, but not limited to, another LAN, or the Internet. Since IP networks share a common method of transmitting data, telecommunication signals may be transmitted between telephony devices located on different, but interconnected, IP networks. In addition to being coupled to other IP networks, communication network 34a may also be coupled to non-IP telecommunication networks through the use of interfaces or components, for example gateway 40. In the illustrated embodiment, communication network 34a is coupled with PSTN 34b through gateway 40. PSTN 34b includes switching stations, central offices, mobile telephone switching offices, pager switching offices, remote terminals, and other related telecommunications equipment that are located throughout the world. IP networks transmit data (including voice and video data) by placing the data in packets and sending each packet individually to the selected destination, along one or more communication paths. Unlike a circuit-switched network (like PSTN 34b), a dedicated circuit is not required for the duration of a call or fax transmission over IP networks.

Technology that allows telecommunications to be transmitted over an IP network may comprise Voice over IP (VoIP), or simply Voice over Packet (VoP). In the illustrated embodiment, endpoint 32d, call managers 38a-38b, and gateway 40 are IP telephony devices. IP telephony devices have the ability of encapsulating a user's voice (or other input) into IP packets so that the voice can be transmitted over network 34a. IP telephony devices may include telephones, fax machines, computers running telephony software, nodes, gateways, or any other device capable of performing telephony functions over an IP network.

In particular embodiments, communication system 30 may receive and transmit data in a session initiation protocol (SIP) environment. SIP is an application-layer control protocol that includes primitives for establishing, modifying, and terminating communication sessions. SIP works independently of underlying transport protocols and without dependency on the type of session that is being established. SIP also transparently supports name mapping and redirection services, which supports personal mobility. In particular embodiments, SIP enables presence technology that allows end users to maintain a single externally visible identifier regardless of their network location. For example, SIP features enable endpoints 32a-32d to discover one another and to agree on a characterization of a session they would like to share. For locating prospective session participants, and for other functions, SIP enables the creation of an infrastructure of network hosts, such as call managers 38a-38c, to which users of endpoints 32a-32d can send registrations, invitations to sessions, and other requests.

The SIP technology allows users of endpoints 32a-32d to query for the presence of a specific user of an end point. This would provide a presence availability status for the end user, as well as location information, device information, and any personal presence status that the caller wishes to communicate to the called party. Hence, communication system 30 builds on existing SIP capabilities and, further, extends them to provide enhanced information to the calling party. This may be achieved using a VoIP platform.

In particular embodiments, SIP may also include primitives supporting session management and/or session setup capabilities. In an example scenario, an end user of endpoint 32a and an end user of endpoint 32b may be communicating with one another in an established communication session when endpoint 32a receives an incoming call from endpoint 32c. For purposes of discussion, the communication session between the end user of endpoint 32a and the end user of endpoint 32b will be hereinafter termed the “previous call.” In accordance with the teachings of the present invention, communication system 30 offers an answer-and-hold feature that allows for effective management of incoming calls to facilitate optimum call sessions between the respective parties. Specifically, the architecture of communication system 30 allows the end user of endpoint 32b to make proactive or real time decisions about the handling of the incoming call from endpoint 32c.

For example, communication system 30 may provide a one-button service that a user may push to invoke the answer-and-hold feature. By pushing a single button or key on endpoint 32a before or after the incoming call from endpoint 32c is received, the end user of endpoint 32a may invoke the answer-and-hold feature to result in the automatic handling of the incoming call. As will be discussed in more detail below, when the feature is invoked, call manager 38a or another network device may intervene to answer the incoming call. While call manager 38a answers the incoming call, the end user of endpoint 32a may finish the previous call without interrupting the one or more participants of the previous call. Once the previous call is terminated, the end user of endpoint 32a may then take the incoming call from endpoint 32c.

With respect to the incoming call, call manager 38a or another network device may deliver an appropriate message to the end user of endpoint 32c. For example, call manager 38a may convey a message stating something similar to the following:
The party whom you are calling is currently on another call. However, the party anticipates that the call will end soon and wishes you to remain on the line. Please hold.
   In particular embodiments, call manager 38a may access database 70 or another database, such as a Unity names database, to provide a personalized message to the end user of endpoint 32c. For example, if the recipient associated with the endpoint 32a receiving the incoming call is Craig Cotton, call manager 38a may access database 70 to determine Craig Cotton is associated with the receiving endpoint 32a. Call manager 38a may then convey a message similar to the following:
‘Craig Cotton’ is currently on another call.

However, the party [or ‘Craig Cotton’] anticipates that the call will end soon and wishes you to remain on the line. Please hold.

Additionally or alternatively, call manager 38a may provide the end user of endpoint 32c with one or more options. For example, the incoming caller may be given the option to hold on the line, leave a message with a voice messaging system, send an instant message to the end user of endpoint 32a, or any combination of these or other options for continuing, modifying, or terminating the communication session.

Furthermore, and as described above, the invoking of the answer-and-hold feature by the recipient of an incoming call may be on a real-time basis or on a proactive basis. Where the invocation of the answer-and-hold feature is on a real-time basis, the recipient of an incoming call may invoke the feature only after the incoming call is received. Thus, the recipient may press a soft key associated with the recipient's endpoint when the endpoint rings to identify the reception of the incoming call. In this manner, the recipient of the incoming call may make decisions for the management of the call on a real-time basis. Where the invocation of the answer-and-hold feature is on a proactive basis, however, the recipient may make a determination that the previous call is wrapping to a close and invoke the answer-and-hold feature by placing himself in a “pending ready” state. In particular embodiments, the recipient may register with a presence server to place himself in a pending ready state. After being placed in the pending ready state, call manager 38a or another network device may intervene to receive any incoming calls.

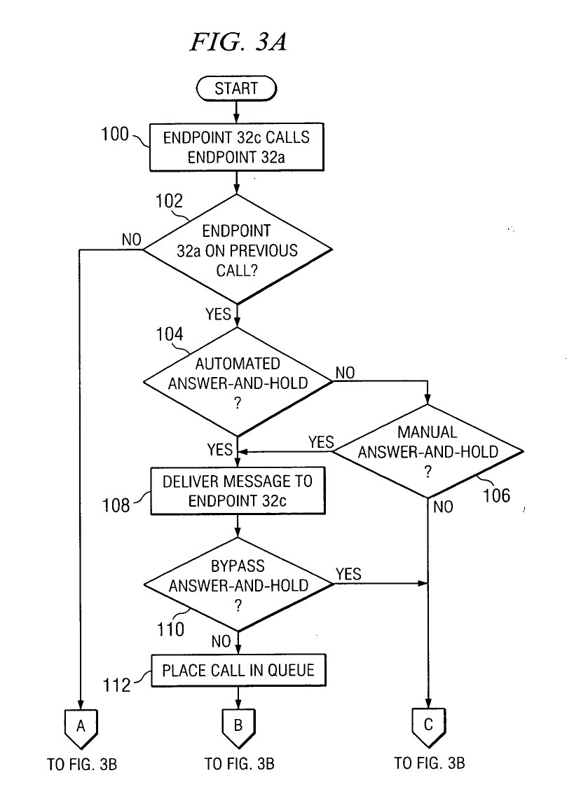

FIG. 2 illustrates call manager 38c in more detail, in accordance with a particular embodiment of the present invention. Call manager 38c includes an interface or input ports 60 which couple call manager 38c with communication network 34a, using segment 40. When a call is received at call manager 38c, a processor 62 and presence server 64 are used to determine which of a plurality of end users 66a-66d should receive the call using endpoints 68a-68d, respectively. In doing so, processor 62 may use presence server 64, a memory lookup, a database, or other memory module, such as memory module 70. Processor 62 may be a microprocessor, controller, or any other suitable computing device or resource. Memory module 70 may be any form of volatile or non-volatile memory including, without limitation, magnetic media, optical media, random access memory (RAM), read-only memory (ROM), removable media, or any other suitable local or remote memory component.

Presence server 62 may be any combination of hardware, software and/or encoded logic, and is used to monitor the presence of an end user at an endpoint. Presence server 62 may detect the presence of an end user at an endpoint in association with one or more of presence clients 72a-72d at the end user's endpoint, for example, at the end user's PC, phone, personal digital assistant (PDA) or any other presence client device (e.g., presence clients 72a-72d). Call manager 38c uses processor 62 to monitor conditions of call manager 38c, such as the number, type or characteristics of calls in queues 78a and 78b or the “state” of each end user. End users may be placed in various states, such as a “ready” state, a “not ready” state, a “talking” state, and a “pending ready” state, according to the current status of the endpoint with respect to call manager 38c. For example, an end user in a ready state may be ready and able to accept an incoming call distributed by call manager 38c. Such an end user may be said to be “available.” Conversely, an end user in a not ready state may be away from his desk or otherwise not ready to accept an incoming call, and an end user in a talking state may currently be communicating on an incoming or outgoing call. In either case, the end user may be said to be “unavailable.” As described above with regard to FIG. 1, an end user in a pending ready state may be currently communicating on a previous call but be ready and able to accept an incoming call using the answer-and-hold feature implemented by call manager 38c. Thus, an end user in this state is neither available or unavailable.

In particular embodiments, an endpoint 68 includes a soft-key or other interface from which the end user can manually transition himself from any supported agent state to and/or from a pending ready state. For example, an end user may manually transition himself to a pending ready state from a talking state while the end user is on a previous call. Whereas calls received while in the talking state may be automatically routed to a voice message system or simply go unanswered, calls received by the end user while in a pending ready state may be intercepted by call manager 38c and placed in a queue 78.

In other embodiments, call manager 38c may automatically transition an end user to a pending ready state based on a characteristic of the previous call or caller, a characteristic of the end user receiving the incoming call, or a characteristic of the caller associated with the incoming call. For example, call manager 38c may automatically transition the end user to a pending ready state when the end user has been on a previous call for a predetermined amount of time. Thus, if the end user has been on a call for 10 minutes, for example, the end user may be automatically transitioned to a pending ready state. As another example, call manager 38c may automatically transition the end user to a pending ready state upon identification of the caller associated with the incoming call if that caller is considered a high priority caller.

In operation, if a suitable end user is not available but is accepting incoming calls on an answer-and-hold basis (i.e., in a pending ready state), the call may be placed into a queue 78 in order to wait for the availability of the appropriate end user. In this embodiment, call manager 38c has two queues 78; however, other embodiments of the present invention may have none, one, or more than two queues 78. The selection of which queue 78 to place an incoming call may depend on the type of caller making the incoming call, the type of service requested in the incoming call or any other characteristic or condition relating to the incoming call, call manager 38c, or the end users.

While an incoming call in queue 78 awaits answering by the recipient, call manager 38c may perform one or more of several functions. These functions may include data collection from the user, the playing of pre-recorded messages, the presentation of the caller with one or more options, or another automated process. For example, call manager 38c may play a message to the caller to inform the caller that the end user with whom the caller desires to speak will be with them shortly and to request the caller to remain on the line. This message allows the pending ready end user to finish the previous call so that the end user may answer the incoming call.

As another example, call manager 38c may play an automated message to the incoming caller to give the incoming caller an option other than remaining on hold. In particular embodiments, call manager 38c may allow the incoming caller to be transferred to a different end user, to leave a message for the end user with a voice message system, or to compose an instant message to be delivered to the end user. If the incoming caller selects any of these or other appropriate options available for redirecting the call, the incoming call may be taken out of queue 78. Distributor 76 may then distribute the call to the appropriate network device for performing the function selected by the incoming caller.

Still another function that may be performed by call manager 38c may include an automatic reminder or alert transmitted to the end user receiving the incoming call. For example, after the incoming call has been placed in queue 78 for a predetermined amount of time, call manager 38c may send an alert to the recipient of the incoming call. Depending on the embodiment implemented, the reminder or alert may include a voice message that is delivered to the recipient of the incoming call, an email message that is delivered to the recipient of the incoming call, an instant message that is displayed on the recipient's computer, or another appropriate communication transmitted or displayed to the recipient. Where call manager 38c barges into the previous call to deliver the alert to the recipient, it may be desirable for the alert to be only heard by the recipient of the incoming call and not by any other participant of the previous call.

The content of the alert may also vary depending on the embodiment implemented. For example, the alert may merely remind the end user that he has received an incoming call that is on hold. In other embodiments, the alert may inform the recipient that the recipient will be disconnected from the previous call and automatically connected with the incoming call if the incoming call is not answered within a given time frame. In still other embodiments, the alert may inform the recipient of the incoming call that the incoming call will be transferred to a voice message system within a given time frame. For example, if the incoming call has been in queue 78 for ninety seconds or another suitable amount of time, the recipient of the incoming call may be informed that the caller will be automatically transferred to a voice message system if the call is not answered within thirty seconds. If the given amount of time elapses without the recipient answering the incoming call, call manager 38c may perform an additional function, in particular embodiments, to automatically transition the recipient of the incoming call from the pending ready state to a talking state. Accordingly, call manager 38c may automatically distribute any additional incoming calls to a voice message system.

In still another embodiment, the alert may allow the recipient of the incoming call to transfer the holding caller into a voice message system. Such an option might be used by a recipient who determines that he will not be able to finish the previous call in a timely fashion. Additionally or alternatively, the recipient may be given an option to send an instant message to the caller being held in queue 78. For example, the recipient might send an instant message to the holding caller to personally acknowledge the presence of the caller in the queue and to reiterate that the recipient will be with the queued caller shortly. As another example, a similar voice message might be delivered to the queued caller.

As soon as the recipient becomes available, distributor 76 of call manager 38c distributes the call to the recipient of the incoming call. In such cases, once a call is routed by distributor 76 to the recipient, the recipient's associated endpoint (e.g., the agent's phone) may ring to alert the end user of the incoming call. The end user may then answer the call. In particular embodiments, the answering of the incoming call by the recipient may result in the recipient end user being automatically transitioned into a talking state. The end user may then manually invoke the answer-and-hold feature for any additional incoming calls or the answer-and-hold feature may be automatically implemented, as described above.

It will be recognized by those of ordinary skill in the art that call manager 38c is merely one example configuration of a call manager for handling and managing incoming calls to end users in communication system 30. Accordingly, it is generally recognized that call manager 38c may include any number of processors, queues, distributors, or memory modules to accomplish the functionality and features described herein. Additionally, processor 62, memory module 70, and/or presence server 64 associated with call manager 38c may be centrally located (local) with respect to one another, or distributed throughout communication network 34a.

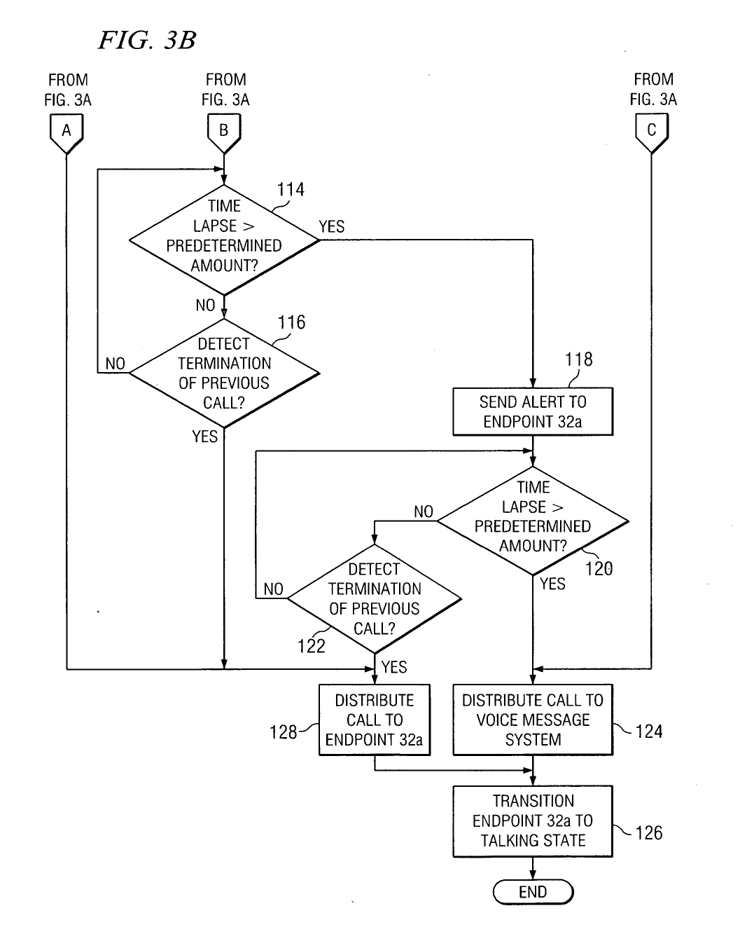

FIGS. 3A and 3B illustrate an example method for implementing an answer-and-hold feature, in accordance with an embodiment of the present invention. The method begins at step 100, where endpoint 32c calls endpoint 32a. In particular embodiments, the call may include a telephone call placed by an end user associated with endpoint 32c to an end user associated with endpoint 32a. A determination may be made at step 102 as to whether the end user of endpoint 32a is on a previous call.

If the end user of endpoint 32a is not on a previous call, the method continues to step 128 where the call is distributed to endpoint 32a. A communication session is then established between endpoint 32a and endpoint 32c.

Returning to step 102, if it is determined that the end user of endpoint 32a is on a previous call, it is determined at step 104 whether the answer-and-hold feature should be automatically invoked. In particular embodiments, determining whether the answer-and-hold feature should be automatically invoked may include detecting that endpoint 32a is in a pending ready state. The pending ready state may be detected when the end user of endpoint 32a has registered with presence server 64 of call manager 38a or another network device to automatically place endpoint 32a in the pending ready state at the occurrence of an event. As just one example, call manager 38c may be configured to automatically place endpoint 32a in the pending ready state when endpoint 32a has been in use on a single call for a predetermined amount of time.

If it is determined that the answer-and-hold feature should not been automatically invoked, it is determined whether answer-and-hold has been manually invoked at step 106. In particular embodiments, the determination may include determining whether the end user of endpoint 32a has pressed a soft-key on endpoint 32a or has used another interface associated with endpoint 32a to invoke the answer-and-hold feature on a real-time basis. The manual invocation of the answer-and-hold feature may be considered to be on a real-time basis where the end user of endpoint 32a uses the interface to invoke the feature as the incoming call from endpoint 32c is received.

If the answer-and-hold feature is not invoked either automatically at step 104 or manually at step 106, the method continues to step 124 where the incoming call from endpoint 32c is distributed to a voice message system. Step 124 is described in further detail below. If the answer-and-hold feature is invoked either automatically or -manually, however, the method continues to step 108 and a message is delivered to endpoint 32c. As described above with regard to FIG. 2, the message delivered to the endpoint 32c may include a statement that the requested party is on another call that is expected to end soon and a request for the end user of endpoint 32c to remain on the line while the previous call is terminated.

At step 110, it is determined whether the end user of endpoint 32c has indicated a desire to bypass the answer-and-hold feature. In particular embodiments, an additional message may be delivered to endpoint 32c giving the end user of endpoint 32c the ability to bypass the answer-and-hold feature. The message may describe to the end user of endpoint 32c, for example, that the end user can be transferred directly to a voice message system if that end user does not wish to wait for the end user of endpoint 32a to terminate the previous call. Where such an option is given to and accepted by the end user of endpoint 32c, the method continues to step 124 where the incoming call from endpoint 32c is distributed to a voice message system as described below.

If the end user of endpoint 32c has not been given an option to bypass the answer-and-hold feature or has elected not to bypass the answer-and-hold feature, the incoming call from endpoint 32c is placed in queue 78 at step 112. The call may remain in queue 78 until it is determined at step 114 that a time lapse of more than a predetermined amount has occurred or until termination of the previous call is detected at step 116.

Where a time lapse greater than a predetermined amount has occurred (i.e., the call manager determines that endpoint 32c has been in queue 78 for too long), an alert may be sent to endpoint 32a at step 118. As described above with regard to FIG. 2, the alert may include a voice message that is played for the end user of endpoint 32a, an email message that is delivered to endpoint 32a, a text message displayed on endpoint 32a, an instant message that is displayed on a computer associated with endpoint 32a, or another appropriate communication transmitted or displayed to the end user of endpoint 32a. The alert may remind the end user of endpoint 32a that he has received an incoming call that is on hold, inform the end user of endpoint 32a that the previous call will be automatically disconnected within a given period of time, or provide any other appropriate message.

After the alert is sent to endpoint 32a at step 118, the call may remain in queue 78 until it is determined at step 120 that a time lapse of more than a predetermined amount has occurred or until termination of the previous call is detected at step 122. Where a time lapse greater than the predetermined amount has occurred (i.e., the call manager determines that the incoming call from endpoint 32c has remained in queue 78 for too long), the call may be distributed to a voice message system at step 124. The end user of endpoint 32c may then be prompted to leave a voice message for the end user of endpoint 32a. Additionally, where presence is detected and managed for endpoint 32a, endpoint 32a may be transitioned from the pending ready state to a talking state after which the method may terminate.

Returning to steps 116 and 122, if termination of the previous call is detected at either step, the method proceeds to step 128 and the call from endpoint 32c is distributed to endpoint 32a. Stated differently, where endpoint 32a terminates the previous call, endpoint 32a is available to take the queued call from endpoint 32c. In particular embodiments, where presence is detected and managed, endpoint 32a may be transitioned from the pending ready state to a ready state. The communication session between endpoint 32a and endpoint 32c may then be initiated and, where applicable, endpoint 32a may be transitioned to a talking state at step 126. The method may then terminate. Alternatively, endpoint 32a may be transitioned directly from a pending ready state to a talking state.

Some of the steps illustrated in FIG. 3 may be combined, modified or deleted where appropriate, and additional steps may also be added to the flowchart. Additionally, steps may be performed in any suitable order without departing from the scope of the invention.

As indicated above, technical advantages of particular embodiments of the present invention include the automated answering and holding of an incoming call. As a result, the recipient of an incoming call may finish a previous call without interruption. Additionally, the participant(s) in the previous call need not know that the end user has received an incoming call and need not know that the end user is finishing the call with them to take the incoming call. As a further advantage, the recipient or an incoming call may avoid time-consuming endeavors, such as unproductive call-backs, that inhibit productivity.

Additionally, in particular embodiments, the invocation of the answer-and-hold feature may be on a real-time basis as the incoming call is received. In other embodiments, a registration system may be used to automatically invoke the answer-and-hold feature. For example, where presence is detected and managed, an end user may pre-register to place himself in a pending-ready state before an incoming call is received. A decision to invoke the answer-and-hold feature on this basis may involve decisions based on the status of a call currently underway. For example, if the call is close to terminating, the end user may press a soft-key on the user's telephone to register the user as willing to receive incoming calls on an automatic answer-and-hold basis. By registering to have incoming calls automatically answered, a user may proactively decide what the best action is to cover incoming calls.

As a result of the invocation of the answer-and-hold feature, all incoming calls to an end user may be adequately covered. As a result, a higher number of successful calls may be completed using the answer-and-hold feature, which vastly improves efficiency parameters (particularly in the workplace). Furthermore, such a protocol may be performed with minimal individual effort from the receiving party, as some or all of the answer-and-hold operations may be performed autonomously.

Although the present invention has been described in detail with reference to particular embodiments, it should be understood that various other changes, substitutions, and alterations may be made hereto without departing from the spirit and scope of the present invention. For example, although the present invention has been described with reference to a number of elements included within a communication system, these elements may be combined, rearranged or positioned in order to accommodate particular routing architectures or needs. In addition, any of these elements may be provided as separate external components to a communication system or to each other where appropriate. The present invention contemplates great flexibility in the arrangement of these elements as well as their internal components.

Numerous other changes, substitutions, variations, alterations and modifications may be ascertained by those skilled in the art and it is intended that the present invention encompass all such changes, substitutions, variations, alterations and modifications as falling within the spirit and scope of the appended claims.

What is claimed is:

1. A method for the automated answering and holding of a call, comprising:
receiving an incoming call directed to a first endpoint from a second endpoint;
detecting that the first endpoint is communicating with a third endpoint on a previous call;
receiving an indication from a recipient of the incoming call that the recipient desires the incoming call to be automatically answered and held;
automatically answering the incoming call from the second endpoint without interrupting the previous call; and
placing the incoming call from the second endpoint in a queue.

2. The method of claim 1, further comprising providing the recipient of the incoming call with an option of selecting between a first state and a second state.

3. The method of claim 2, wherein the second state results in the automatic answering and holding of the incoming call.

4. The method of claim 2, wherein receiving the indication from the recipient comprises receiving a request to transition the first endpoint from the first state to the second state, the second state comprising a pending ready state.

5. The method of claim 1, wherein:
the indication from the recipient is received after the incoming call is received; and
the incoming call is automatically answered without interrupting the previous call in response to receiving the indication.

6. The method of claim 5, wherein the indication from the recipient is received as a result of a depression, by the recipient, of a soft-key on the first endpoint.

7. The method of claim 1, further comprising:
determining that a predetermined amount of time has lapsed since the incoming call was placed in the queue; and
delivering an alert to the first endpoint.

8. The method of claim 1, further comprising:
determining that a predetermined amount of time has lapsed since the incoming call was placed in the queue; and
providing a user-selectable option to an end user of the second endpoint that allows the end user of the second endpoint to leave a voice message for an end user of the first endpoint.

9. The method of claim 1, further comprising delivering a pre-recorded message to the second endpoint, the pre-recorded message requesting an end user of the second endpoint to hold.

10. The method of claim 1, further comprising:
detecting the termination of the previous call; and
distributing the incoming call to the first endpoint.

11. A system for the automated answering and holding a call, comprising:
a processor operable to:
receive an incoming call directed to a first endpoint, the incoming call communicated from a second endpoint;
detect that the first endpoint is communicating with a third endpoint on a previous call;
receive an indication from a recipient of the incoming call that the recipient desires the incoming call to be automatically answered and held; and
automatically answer the incoming call from the second endpoint without interrupting the previous call; and
a queue in data communication with the processor, the queue operable to store the incoming call from the second endpoint while the first endpoint is on the previous call.

12. The system of claim 11, wherein the processor is further operable to provide the recipient of the incoming call with an option of selecting between a first state and a second state.

13. The system of claim 12, wherein the second state results in the automatic answering and holding of the incoming call.

14. The system of claim 12, wherein receiving the indication from the recipient comprises receiving a request to transition the first endpoint from the first state to the second state, the second state comprising a pending ready state.

15. The system of claim 11, wherein the processor is further operable to:
receive the indication from the recipient after the incoming call is received; and
automatically answer the incoming call without interrupting the previous call in response to receiving the indication.

16. The system of claim 15, wherein the indication from the recipient is received as a result of a depression, by the recipient, of a soft-key on the first endpoint.

17. The system of claim 11, wherein the processor is further operable to:
determine that a predetermined amount of time has lapsed since the incoming call was placed in the queue; and
deliver an alert to the first endpoint.

18. The system of claim 11, wherein the processor is further operable to:
determine that a predetermined amount of time has lapsed since the incoming call was placed in the queue; and
provide a user-selectable option to an end user of the second endpoint that allows the end user of the second endpoint to leave a voice message for an end user of the first endpoint.

19. The system of claim 10, wherein the processor is further operable to deliver a pre-recorded message to the second endpoint requesting an end user of the second endpoint to hold.

20. The system of claim 11, wherein the processor is further operable to:
detect the termination of the previous call; and
distribute the incoming call to the first endpoint.

21. A system for the automated answering and holding of a call, comprising:
means for receiving an incoming call directed to a first endpoint from a second endpoint;
means for detecting that the first endpoint is communicating with a third endpoint on a previous call;
means for receiving an indication from a recipient of the incoming call that the recipient desires the incoming call to be automatically answered and held;
means for automatically answering the incoming call from the second endpoint without interrupting the previous call; and
means for placing the incoming call from the second endpoint in a queue.

22. Logic embodied in a computer readable medium, the computer readable medium comprising code operable to:
receive an incoming call directed to a first endpoint from a second endpoint;
detect that the first endpoint is communicating with a third endpoint on a previous call;
receive an indication from a recipient of the incoming call that the recipient desires the incoming call to be automatically answered and held;
automatically answer the incoming call from the second endpoint without interrupting the previous call; and
place the incoming call from the second endpoint in a queue.

23. A method for the automated answering and holding of a call, comprising:
receiving a request from a first endpoint to transition the first endpoint from a talking state to a pending ready state;
transitioning the first endpoint into the pending ready state in response to receiving the request;
receiving an incoming call directed to the first endpoint from a second endpoint;
detecting that the first endpoint is in a pending ready state;
automatically answering the incoming call from the second endpoint without interrupting a previous call;
delivering a pre-recorded message to the second endpoint, the pre-recorded message requesting an end user of the second endpoint to hold;
placing the incoming call from the second endpoint in a queue;
detecting the termination of the previous call;
removing the incoming call from the queue; and
distributing the incoming call to the first endpoint.
